(19) United States
(12) Patent Application Publication
(10) Pub. No.: US 2014/0358872 A1
(43) Pub. Date: Dec. 4, 2014

(54) STORAGE SYSTEM AND METHOD FOR PERFORMING DEDUPLICATION IN CONJUNCTION WITH HOST DEVICE AND STORAGE DEVICE

(71) Applicant: SAMSUNG ELECTRONICS CO., LTD., Suwon-si (KR)

(72) Inventors: Hyun-jung SHIN, Yongin-si (KR); Ju-Pyung LEE, Suwon-si (KR)

(73) Assignee: SAMSUNG ELECTRONICS CO., LTD., Suwon-si (KR)

(21) Appl. No.: 14/290,084

(22) Filed: May 29, 2014

(30) Foreign Application Priority Data
May 31, 2013 (KR) 10-2013-0063006

(51) Int. Cl. G06F 17/30; H04L 29/08

(52) U.S. Cl. CPC G06F 17/30156; H04L 67/06
USPC 707/692

(57) ABSTRACT

Provided is a method for performing deduplication in conjunction with a host device and a storage device, and a storage system therefor. The host device includes a brief examination device which is configured to briefly examine whether data to be stored is duplicated or not based on a hash value of the data to be stored, and a data transmission device which is configured to transmit the data to be stored with an examination request or a data storage request to the at least one storage device according to a result of the examination.

### CROSS-REFERENCE TO RELATED APPLICATION

This application claims priority from Korean Patent Application No. 10-2013-0063006 filed on May 31, 2013, in the Korean Intellectual Property Office, the disclosure of which is hereby incorporated by reference in its entirety.

### BACKGROUND

1. Field

Exemplary embodiments relate to deduplication technology. In particular, exemplary embodiments relate, to a method for performing deduplication in conjunction with a host device and a storage device, and a storage system therefor.

2. Description of the Related Art

Deduplication is a related art technique for efficiently managing duplicate data by managing the duplicate data using link values without redundantly storing the same data. Since the deduplication technique improves storage utilization and reduces the amount of data transmitted to a network, it is required for a large data storage system.

Deduplication has been mostly utilized in secondary storages, including a backup storage. In recent years, attempts are being made to utilize deduplication in primary storages as well. Accordingly, it is necessary to reduce adverse effects on an operation of a system by minimizing deduplication overhead.

### SUMMARY

According to an aspect of an exemplary embodiment, there is provided a host device for performing a deduplication process in conjunction with at least one storage device, the host device including a brief examination device which is configured to briefly examine whether data to be stored is duplicated or not based on a hash value of the data to be stored, and a data transmission device which is configured to transmit the data to be stored with an examination request or a data storage request to the at least one storage device according to a result of the examination.

According to another aspect of an exemplary embodiment, there is provided a storage device storage device for performing a deduplication process in conjunction with a host device, the storage device including an examination device which is configured to examine whether data is duplicated or not by comparing data received from the host device with pre-stored data having a same hash value with the received data, according to an examination request of data duplication from the host device, and a deduplication device which is configured to remove duplicate data according to a result of the examination.

According to still another aspect of an exemplary embodiment, there is provided a storage system performing a deduplication process, the storage system including a host device which is configured to perform data duplication examination on a hash value of data to be stored and transmit a result of the data duplication examination to a storage device, and the storage device which is configured to examine whether the data to be stored is duplicate data or not by comparing the data to be stored with pre-stored data having a same hash value with the data to be stored according to the result of the data duplication examination transmitted from the host device.

According to yet another aspect of an exemplary embodiment, there is provided a method for performing a deduplication process in conjunction with a host device and a storage device, the method including briefly examining whether data to be stored is duplicate data in the host device, transmitting a result of the brief examination to the storage device, and comprehensively examining whether the data to be stored is duplicate data in the storage device based on the result of the brief examination from the storage device.

### BRIEF DESCRIPTION OF THE DRAWINGS

The above and other features and advantages of the exemplary embodiments will become more apparent by describing in detail preferred embodiments thereof with reference to the attached drawings in which:

FIG. 1 is a schematic diagram of a storage system performing a deduplication process in conjunction with a host device and a storage device, according to an embodiment ;

FIG. 2 is a detailed diagram of the storage system shown in FIG. 1;

FIG. 3 is a flowchart illustrating a method for offloading a deduplication process of a host device performing a deduplication process in conjunction with a storage device, according to an embodiment;

FIG. 4 is a schematic diagram of a host device performing a deduplication process in conjunction with a storage device, according to an embodiment;

FIG. 5 is a schematic diagram of a storage device performing a deduplication process in conjunction with a host device, according to an embodiment;

FIG. 6 is a schematic diagram of a storage device performing a deduplication process in conjunction with a host device, according to another embodiment;

FIG. 7 is a flowchart illustrating an operating method of a host device performing a deduplication process in conjunction with a storage device, according to an embodiment;

FIG. 8 is a flowchart illustrating an operating method of a storage device performing a deduplication process in conjunction with a host device, according to an embodiment; and

FIG. 9 is a flowchart illustrating a method for performing a deduplication process in conjunction with a host device and a storage device, according to an embodiment.

### DETAILED DESCRIPTION OF THE EXEMPLARY EMBODIMENTS

Advantages and features of the exemplary embodiments and methods of accomplishing the same may be understood more readily by reference to the following detailed description of preferred embodiments and the accompanying drawings. The exemplary embodiments may, however, be embodied in many different forms and should not be construed as being limited to the embodiments set forth herein. Rather, these embodiments are provided so that this disclosure will be thorough and complete and will fully convey the concept of the exemplary embodiments to those skilled in the art. The exemplary embodiments will only be defined by the appended claims. Like reference numerals refer to like elements throughout the specification.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the exemplary embodiments.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, e.g., of manufacturing techniques and/or tolerances, are to be expected. Thus, these embodiments should not be construed as limited to the particular shapes of regions illustrated herein but are to include deviations in shapes that result, e.g., from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the exemplary embodiments.

Unless otherwise defined, all terms (including technical and scientific terms) used herein have the same meaning as commonly understood by one of ordinary skill in the art to which the exemplary embodiments belong. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

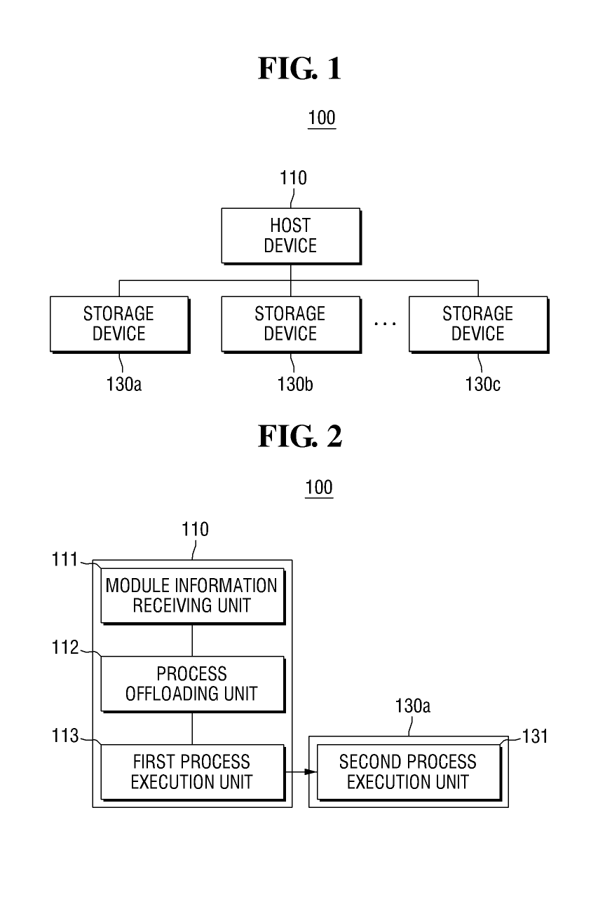

FIG. 1 is a schematic diagram of a storage system performing a deduplication process in conjunction with a host device and a storage device, according to an embodiment, and FIG. 2 is a detailed diagram of the storage system shown in FIG. 1. In describing the storage system shown in FIGS. 1 and 2, it is assumed that the deduplication process consists of a first process and a second process.

Referring to FIGS. 1 and 2, the storage system 100 according to an embodiment can be applied to a storage module including a plurality of storage devices 130a to 130c. The storage module including the plurality of storage devices 130a to 130c may include a storage array in which the plurality of storage devices 130a to 130c are constructed as a single node, and a distributed storage module in which the plurality of storage devices 130a to 130c are distributed to a plurality of nodes connected by a network. However, aspects of the exemplary embodiments are not limited thereto. The storage system 100 according to an embodiment may also be applied to a storage module including a single storage device.

Each of the storage devices 130a to 130c may be implemented by a solid state drive or solid state disk (SSD). However, the storage devices 130a to 130c can be implemented in various types without being limited to SSDs. For example, the storage devices 130a to 130c may be integrated into one semiconductor device to be implemented as a PC card such as a personal computer memory card international association (PCMCIA) card, a compact flash (CF) card, a smart media card (e.g., SM or SMC), a memory stick, a multimedia card (e.g., MMC, RS-MMC or MMCmicro), a SD card (e.g., SD, miniSD, microSD and SDHC), or a universal flash storage (UFS).

The host device 110 may include a module information receiving unit 111 and a process offloading unit 112.

The module information receiving unit 111 may receive information regarding a deduplication module included in each of the storage devices 130a to 130c (hereinafter, deduplication module information) from each of the storage devices 130a to 130c. The deduplication module is a module processing the overall deduplication process in part or in whole. The deduplication module may include, e.g., one or more modules selected from a brief examination module which briefly examines whether data is duplicated or not using a hash function, a thorough examination module which thoroughly examines whether data is duplicated or not by bit-wise comparison or byte-wise comparison, a compression module which compresses data, and a delta encoding module which delta-encodes data. The deduplication module information may include information regarding types and functions of deduplication modules included in each of the storage devices 130a to 130c.

The process offloading unit 112 may offload the overall deduplication process in part or in whole to the storage device 130a based on the deduplication module information received from the storage device 130a associated with the host device 110 to perform the deduplication processes.

For example, similar to the exemplary the storage system shown in FIG. 2, if the storage device 130a includes a second process execution unit 131 (i.e., second deduplication module) which performs a second process, the process offloading unit 112 may offload the second process to the storage device 130a. Therefore, under this scenario, a first process execution unit 113 (i.e., first deduplication module) of the host device 110 is allowed to perform a first process, and the second process execution unit 131 (i.e., second deduplication module) of the storage device 130a is allowed to perform the second process.

Accordingly, the overall deduplication process is offloaded in part or in whole to the storage device. Therefore, host processing overhead is minimized while increasing deduplication efficiency.

Each of the storage devices 130b and 130c include the same constituent elements and functions as those of the storage device 130a. Therefore, the description of the storage device 130a may also apply to the storage devices 130b and 130c.

It has been assumed that the deduplication process is comprised of the first and second processes, but aspects of the exemplary embodiments are not limited thereto. Many sub processes may be added or skipped according to the use and performance of the system.

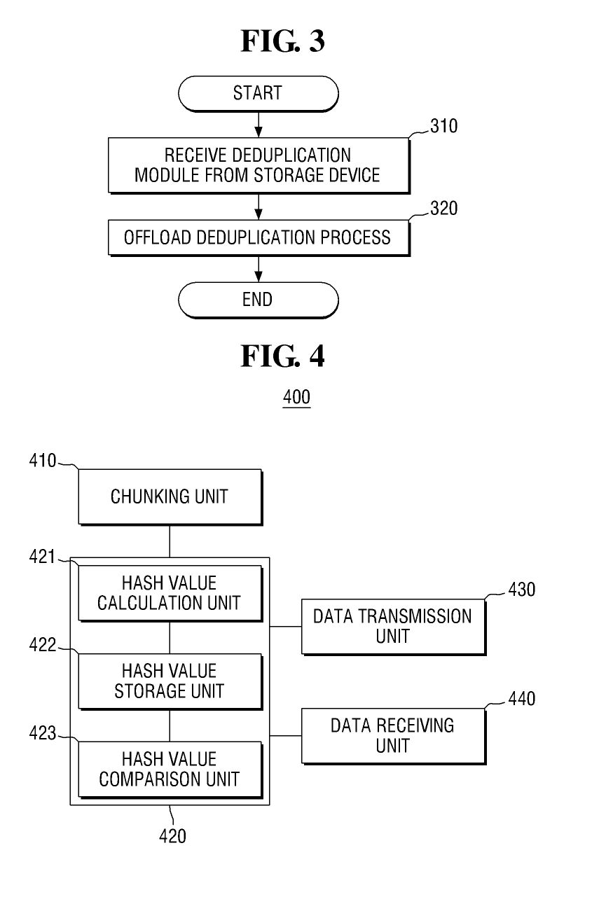

FIG. 3 is a flowchart illustrating a method for offloading a deduplication process of a host device performing a deduplication process in conjunction with a storage device according to an embodiment. It is assumed that the deduplication process is comprised of multiple sub processes.

Referring to FIG. 3, the method for offloading a deduplication process of a host device performing a deduplication process in conjunction with a storage device includes receiving deduplication module information from the storage device to perform the deduplication process in conjunction with the host device (310).

The deduplication module may include one or more modules performing the overall deduplication process in part or in whole. The deduplication module may include, e.g., a brief examination unit which briefly examines whether the data is duplicated or not using, e.g., a hash function, a thorough examination module which thoroughly examines whether the data is duplicated or not using, for e.g., bit-wise comparison or byte-wise comparison, a compression module which compresses data, and a delta encoding module which performs delta encoding. The deduplication module information may include information regarding types and functions of deduplication modules included in each of the storage devices 130a to 130c.

Thereafter, sub processes associated with the deduplication process are offloaded based on the received deduplication module information (320).

For example, when the storage device includes a deduplication module performing the second process, the host device may not perform the second process but may offload the second process to the storage device.

Hereinafter, for convenience, it is assumed that the deduplication process includes sub processes, such as a brief examination process and a thorough examination process for examining data duplication. The storage device includes a thorough examination module which performs a thorough examination process to thoroughly examine data duplication.

FIG. 4 is a schematic diagram of a host device performing a deduplication process in conjunction with a storage device, according to an embodiment.

Referring to FIG. 4, the host device 400 according to an embodiment may include a brief examination unit 420 and a data transmission unit 430.

The brief examination unit 420 may briefly examine whether the data is duplicated or not by comparing a hash value of data to be stored (hereinafter, referred to as storage requested data) with a pre-stored hash value. The brief examination unit 420 may include a hash value calculation unit 421, a hash value storage unit 422, and a hash value comparison unit 423.

The hash value calculation unit 421 may calculate the hash value of the storage requested data using a hash algorithm or a hash function. For example, the hash value calculation unit 421 may calculate the hash value of the storage requested data using various hash functions or hash algorithms such as GOST, HAVAL, MD2, MD4, MD5, PANAMA, RadioGatún, RIPEMD, RIPEMD-128/256, RIPEMD-160, RIPEMD-320, SHA-0, SHA-1, SHA-256/224, SHA-512/384, SHA-3, or WHIRLPOOL.

In addition, when the storage device associated with the host device 400 includes a delta encoding module, the hash value calculation unit 421 may calculate a hash value using similarity based hashing, rather than cryptographic hashing. The similarity based hashing produces little change in the hash value when there is a slight difference in the data, while the cryptographic hashing produces a sharp change in the hash value even when there is a slight difference in the data. Therefore, the similarity based hashing is used when determining data similarity only by hash value comparison. In this case, if the brief examination result proves that the storage requested data is not duplicate data, the host device 400 may transmit the storage requested data to the storage device in which data has a similar hash value to the storage requested data.

The hash value storage unit 422 may store hash values calculated by the hash value calculation unit 421 in the form of a hash table.

The hash value comparison unit 423 compares the hash value calculated by the hash value calculation unit 421 with the hash value pre-stored in the hash value storage unit 422 to briefly examine whether data is duplicate data or not. For example, if the same hash value as the hash value calculated by the hash value calculation unit 421 does not exist, it is determined that the storage requested data is not duplicate data.

The hash value comparison based on the hash algorithm or the hash function may cause a problem of collisions between different data having the same hash value. To avoid the collisions, thorough examination by bit-wise comparison or byte-wise comparison may be performed. In this case, a collision free scenario can be ensured when using a hash function for small-sized hash value outputs, i.e., a hash function having a high probability of collisions. In deduplication, the hash value calculated using a hash function is used as a hash value of file-based data or chunk-based data to then be stored in RAM (e.g., the hash value storage unit 422). The smaller the file-based data or chunk-based data size or the larger the amount of data, the more amount of RAM (e.g., hash value storage unit 422, etc.) used. In other words, in a case of performing thorough examination using bit-wise comparison or byte-wise comparison, even if a SHA-256 hash function for 256-bit hash outputs is replaced with a MD5 hash function for 128-bit hash outputs, a collision free scenario can be ensured.

Alternatively, the brief examination of data duplication may also be performed by other methods for calculating a smaller value than the hash value calculated by the hash function, such as a signature or a fingerprinting. In other words, the brief examination unit 420 may briefly examine whether data is duplicated or not, by methods other than comparison of hash values calculated by the hash function.

If the comparison result by the hash value comparison unit 423 proves that the same hash value as the hash value calculated by the hash value calculation unit 421 is pre-stored in the hash value storage unit 422, the data transmission unit 430 may transmit the storage requested data with a request for thorough examination to the storage device storing data having the hash value according to the examination result.

In addition, if the comparison result by the hash value comparison unit 423 proves that the same hash value as the hash value calculated by the hash value calculation unit 421 is not pre-stored in the hash value storage unit 422, the data transmission unit 430 may transmit the storage requested data with a data storage request signal to a storage device storing the storage requested data. If the storage device has a delta encoding module mounted therein, the data transmission unit 430 may transmit the storage requested data to a storage device storing data having a hash value similar to that of the storage requested data.

Meanwhile, according to an exemplary embodiment, the host device 400 may further include a request signal generator (not shown) which generates a thorough examination request signal, a data storage request signal, etc.

According to an exemplary embodiment, the storage requested data may be file-based data or block-based data. In the latter case, the host device 400 may further include a chunking unit 410.

If there is a request for new data to be stored (i.e., storage requested data) from a user, the chunking unit 410 may chunk the storage requested data and may generate block-based data. For example, the chunking unit 410 may chunk the storage requested data with a fixed length or with variable lengths. In addition, when necessary, the chunking unit 410 may collect small sized data to generate block-based data having larger sizes.

According to additional embodiments, the host device 400 may further include a data receiving unit 440. The data receiving unit 440 may receive a deduplication result from the storage device which performs a deduplication process in conjunction with the host device 400. The host device 400 may utilize the received deduplication result in establishing cache policies or in updating a hash table of the hash value storage unit 422.

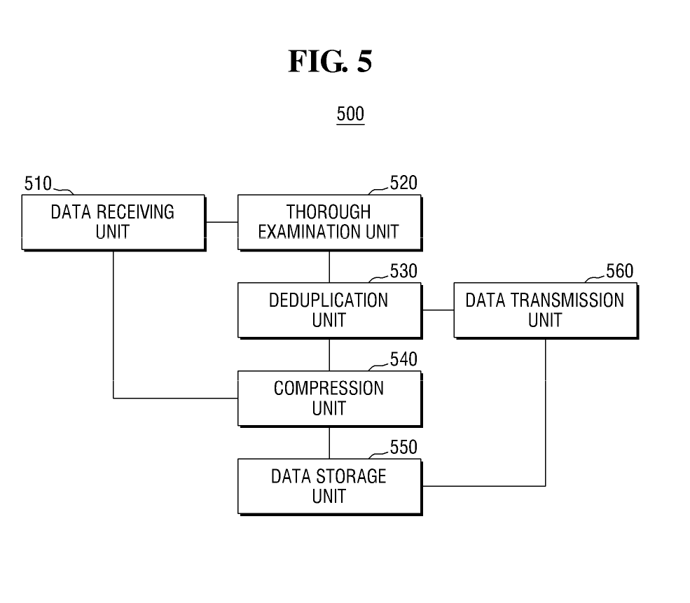

FIG. 5 is a schematic diagram of a storage device (500) performing a deduplication process in conjunction with a host device, according to an embodiment.

Referring to FIG. 5, the storage device 500 according to an embodiment may include a thorough examination unit 520, a deduplication unit 530, and a data storage unit 550.

The thorough examination unit 520 is a module for thoroughly examining whether data is duplicated or not by comparing storage requested data received from a host device with pre-stored data, according to a thorough examination request signal from the host device. According to an embodiment, the thorough examination unit 520 may compare the storage requested data with the pre-stored data having the same hash value as the storage requested data by a bit-wise comparison or a byte-wise comparison.

If the thorough examination result from the thorough examination unit 520 proves that the storage requested data received from the host device is the same as the pre-stored data, the deduplication unit 530 may remove the storage requested data. According to an embodiment, the deduplication unit 530 may link a pointer for the data that is the same as the storage requested data, and may then remove the storage requested data without storing the same.

If there is a data storage request from the host device, the data storage unit 550 or the thorough examination result from the thorough examination unit 520 proves that the storage requested data received from the host device is not duplicated with the pre-stored data, the data storage unit 550 may store the storage requested data. The data storage unit 550 may be a flash memory (e.g., a NAND flash memory), but aspects of the exemplary embodiments are not limited. Examples of the data storage unit 550 may include other types of nonvolatile memories, such as PRAM, FRAM, MRAM, etc.

According to additional embodiments, the storage device 500 may further include a compression unit 540 which compresses the storage requested data received from the host device. The compression unit 540 is a compression module that may compress the storage requested data before storing the storage requested data in the data storage unit 550.

The compression, which is performed after the deduplication, may further increase a capacity saving effect. The processing overhead derived from compression can be reduced by performing the compression in the storage device 500. The smaller the chunk size, the higher the deduplication efficiency, and the higher the processing overhead. Conversely, the larger the chunk size, the higher the compression efficiency. Therefore, a greater capacity saving effect can be exerted in a case of performing deduplication with a larger chunk size and then performing compression than in a case of performing deduplication with a smaller chunk size and then performing compression. Since the same capacity saving effect can be achieved by compression with an increased chunk size, the dimension of a hash table can be reduced while improving the deduplication throughput. Thus, the deduplication overhead is reduced, and a deduplication execution time is shortened.

According to additional embodiments, the storage device 500 may further include a data receiving unit 510 and a data transmission unit 560.

The data receiving unit 510 may receive storage requested data with a thorough examination request signal from the host device. In addition, the data receiving unit 510 may receive the storage requested data with the data storage request signal from the host device. The data transmission unit 560 may transmit the deduplication result to the host device.

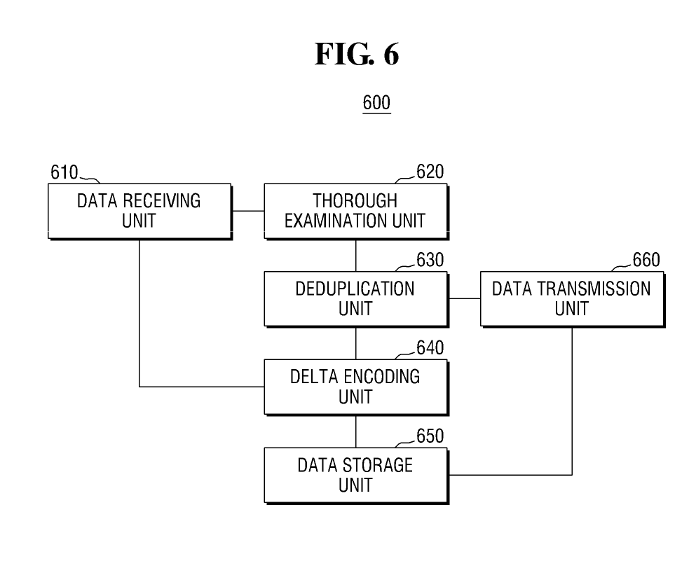

FIG. 6 is a schematic diagram of a storage device (600) performing a deduplication process in conjunction with a host device, according to another embodiment;

Referring to FIG. 6, the storage device 600 according to another embodiment may include a data receiving unit 610, a thorough examination unit 620, a deduplication unit 630, a delta encoding unit 640, a data storage unit 650, and a data transmission unit 660.

When compared with the storage device 500 shown in FIG. 5, the storage device 600 includes the same constituent elements as those of the storage device 500, except for the delta encoding unit 640. In other words, the data receiving unit 610, the thorough examination unit 620, the deduplication unit 630, the data storage unit 650 and the data transmission unit 660 perform the same functions as the corresponding constituent elements of the storage device 500 shown in FIG. 5, respectively. Thus, detailed descriptions thereof will be omitted.

The delta encoding unit 640 corresponds to the compression unit 540 of FIG. 5, and is a delta encoding module that delta-encodes the storage requested data before storing the storage requested data in the data storage unit 650.

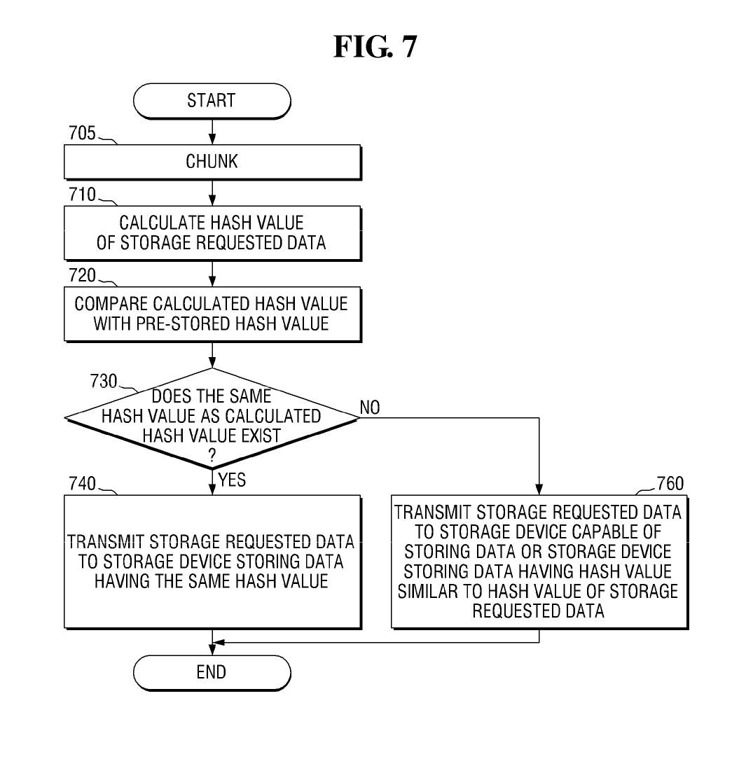

FIG. 7 is a flowchart illustrating an operating method of a host device performing a deduplication process in conjunction with a storage device, according to an embodiment.

Referring to FIG. 7, the operating method of a host device according to an embodiment includes calculating a hash value of storage requested data (710). The hash value of the storage requested data may be calculated using, e.g., a hash algorithm or a hash function, such as GOST, HAVAL, MD2, MD4, MD5, PANAMA, RadioGatún, RIPEMD, RIPEMD-128/256, RIPEMD-160, RIPEMD-320, SHA-0, SHA-1, SHA-256/224, SHA-512/384, SHA-3, or WHIRLPOOL.

Thereafter, the calculated hash value is compared with a pre-stored hash value (720), and it is determined whether there is a hash value that is the same as the calculated hash value (730).

If it is determined in step 730 that the same hash value as the calculated hash value exists, the storage requested data with a thorough examination request signal is transmitted to the storage device storing the data having the same hash value (740).

If it is not determined in step 730 that the same hash value as the calculated hash value exists, the storage requested data is transmitted with the data storage request signal to a storage device capable of storing the storage requested data or a storage device storing data having a hash value similar to that of the storage requested data (760). For example, when the storage device includes a delta encoding module, the storage requested data is transmitted to a storage device storing data having a hash value similar to that of the storage requested data. When the storage device does not include a delta encoding module, the storage requested data is transmitted to a storage device capable of storing the storage requested data.

The storage requested data may be file-based data or block-based data. In the block-based data, the operating method of the host device performing a deduplication process may further include chunking storage requested data (705).

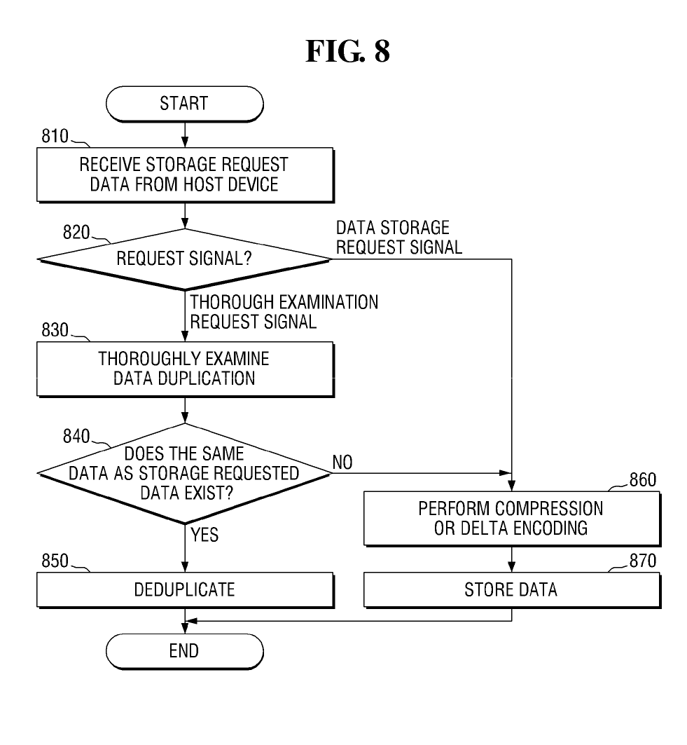

FIG. 8 is a flowchart illustrating an operating method of a storage device performing a deduplication process in conjunction with a host device, according to an embodiment.

Referring to FIG. 8, the operating method of the storage device according to an embodiment includes receiving storage requested data and a request signal from a host device (810) and determining whether the received request signal is a thorough examination request signal or a data storage request signal (820).

If the received request signal is a thorough examination request signal, the received storage requested data is compared with pre-stored data to thoroughly examine whether the data is duplicate data (830). Then, it is determined whether the data that is the same as the received storage requested data exists in the pre-stored data (840). For example, the storage requested data is compared with the pre-stored data having the same hash value as the storage requested data by bit-wise comparison or byte-wise comparison to determine whether the data is duplicate data or not.

If it is determined in step 840 that the data that is the same as the received storage requested data exists in the pre-stored data, the storage requested data that is duplicate data is removed (850). If it is not determined in step 840 that the data that is the same as the received storage requested data exists in the pre-stored data, the storage requested data is compressed or delta-encoded (860), and the compressed or delta-encoded storage requested data is stored (870).

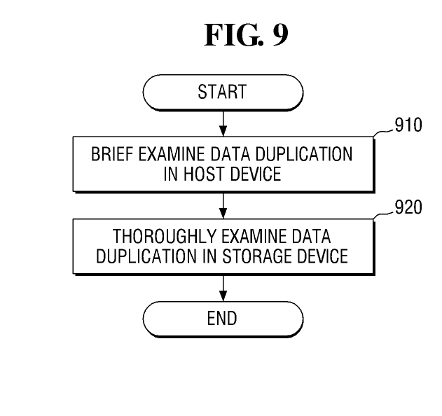

FIG. 9 is a flowchart illustrating a method for performing a deduplication process in conjunction with a host device and a storage device, according to an embodiment.

Referring to FIG. 9, the method for performing a deduplication process according to an embodiment includes the host device briefly examining whether data to be stored is duplicate data, and transmitting a brief examination result to the storage device (910). For example, the host device may calculate a hash value of the data to be stored and the calculated hash value is compared with a pre-stored hash value to briefly examine whether data to be stored is duplicate data. The data to be stored is file-based data or block-based data.

Thereafter, according to the brief examination result received from the host device, the storage device thoroughly examines whether the data to be stored is duplicate data (920). For example, if the brief examination result proves that the data to be stored is duplicate data, the storage device (e.g., storage device 130a of FIG. 1) may compare the data to be stored with the pre-stored data having the same hash value by a bit-wise comparison or a byte-wise comparison to thoroughly examine whether the data to be stored is duplicate data.

Although not shown, if the examination result of step 910 or 920 proves that the data to be stored is not duplicate data, the method for performing a deduplication process according to an embodiment may further include the storage device compressing or delta-encoding the data to be stored, and storing the compressed or delta-encoded data.

According to another exemplary embodiment, any of the hash value calculation unit 421, the hash value storage unit 422, the hash value comparison unit 423, the data transmission unit 430, the data receiving unit 440, the data receiving unit 510, the thorough examination unit 520, the deduplication unit 530, the compression unit 540, the data storage unit 550, the data transmission unit 560, the data receiving unit 610, the thorough examination unit 620, the deduplication unit 630, the delta encoding unit 640, the data storage unit 650, and the data transmission unit 660 may include at least one processor, a hardware module, or a circuit for performing their respective functions.

The exemplary embodiments can also be embodied as computer-readable codes on a computer-readable medium. Also, codes for implementing the program and code segments to accomplish the exemplary embodiments can be easily construed by programmers skilled in the art to which the exemplary embodiments pertain. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion.

While exemplary embodiments have been particularly shown and described, it will be understood by those of ordinary skill in the art that various changes in form and details may be made therein without departing from the spirit and scope of the exemplary embodiments as defined by the following claims. It is therefore desired that the present embodiments be considered in all respects as illustrative and not restrictive. Therefore, reference should be made to the appended claims, rather than the foregoing description to indicate the scope of the exemplary embodiments.

What is claimed is:

1. A host device for performing a deduplication process in conjunction with at least one storage device, the host device comprising:
a brief examination device which is configured to briefly examine whether data to be stored is duplicated or not based on a hash value of the data to be stored; and
a data transmission device which is configured to transmit the data to be stored with an examination request or a data storage request to the at least one storage device according to a result of the brief examination.

2. The host device of claim 1, wherein the brief examination device comprises:
a hash value calculation device which is configured to calculate a hash value of the data to be stored; and
a hash value comparison device which is configured to compare the calculated hash value with a pre-stored hash value.

3. The host device of claim 1, wherein the data to be stored is file-based data or block-based data.

4. The host device of claim 1, wherein the data transmission device is further configured to transmit the data to be stored to the at least one storage device, in which data having a same hash value with the data to be stored is stored, together with the examination request of data duplication in response to the data to be stored being duplicate data, and
wherein the data transmission device is further configured to transmit the data to be stored to the at least one storage device, in which the data to be stored is capable of being stored, together with the data storage request in response to the data to be stored not being duplicate data.

5. A storage device for performing a deduplication process in conjunction with a host device, the storage device comprising:
an examination device which is configured to examine whether data is duplicated or not by comparing data received from the host device with pre-stored data having a same hash value with the received data, according to an examination request of data duplication from the host device; and
a deduplication device which is configured to remove duplicate data according to a result of the examination.

6. The storage device of claim 5, wherein the examination device is further configured to compare the received data with the pre-stored data by a bit-wise comparison or a byte-wise comparison.

7. The storage device of claim 5, further comprising a data storage device which is configured to store the received data in response to the result of the examination being that there is a data storage request from the host device or that the received data is not duplicate data.

8. The storage device of claim 7, further comprising a compression device which is configured to compress the received data before storing the received data in the data storage device.

9. The storage device of claim 7, further comprising a delta encoding unit delta-which is configured to encode the received data before storing the received data in the data storage unit.

10. A storage system performing a deduplication process, the storage system comprising:
a host device which is configured to perform data duplication examination on a hash value of data to be stored and transmit a result of the data duplication examination to a storage device; and
the storage device which is configured to examine whether the data to be stored is duplicate data or not by comparing the data to be stored with pre-stored data having a same hash value with the data to be stored according to the result of the data duplication examination transmitted from the host device.

11. The storage system of claim 10, wherein the data to be stored is file-based data or block-based data.

12. The storage system of claim 10, wherein the storage device is further configured to examine whether the data to be stored is duplicated by comparing the data to be stored with the pre-stored data by a bit-wise comparison or a byte-wise comparison.

13. The storage system of claim 10, wherein the storage device comprises a solid state drive or solid state disk (SSD).

14. The storage system of claim 10, wherein the storage device stores the data to be stored by compressing or delta-encoding the data to be stored in response to the data to be stored not being determined as duplicate data according to the result of the data duplication examination transmitted from the host device.

15. A method for performing a deduplication process in conjunction with a host device and a storage device, the method comprising:
briefly examining whether data to be stored is duplicate data in the host device;
transmitting a result of the brief examination to the storage device; and
comprehensively examining whether the data to be stored is duplicate data in the storage device based on the result of the brief examination from the storage device.

16. The method of claim 15, further comprising:
removing duplicate data by the storage device based on a result of the brief examination in the storage device.

17. The method of claim 15, further comprising:
compressing or delta-encoding the data to be stored, and storing the compressed or the delta-encoded data in the storage device in response to the data to be stored not being determined as duplicate data according to the result of the brief examination transmitted to the storage device.

18. The method of claim 15, wherein the data to be stored is file-based data or block-based data.

19. The method of claim 15, wherein the briefly examining whether the data to be stored is duplicate data in the host device further comprises:
calculating a hash value of the data to be stored; and
comparing the calculated hash value with a pre-stored data having a same hash value to briefly examine whether the data to be stored is duplicate data.

20. The method of claim 19, wherein the comprehensively examining whether the data to be stored is duplicate data in the storage device further comprises:
comparing the data to be stored with the pre-stored data having the same hash value by a bit-wise comparison or a byte-wise comparison to comprehensively examine whether the data to be stored is duplicate data.
